(19) United States
(12) Patent Application Publication
(10) Pub. No.: US 2011/0017584 A1
(43) Pub. Date: Jan. 27, 2011

(54) Desalination System and Method

(76) Inventors: Gary L. Stevenson, Houston, TX (US); Jonathan Gilchrist, Houston, TX (US); David Mordekhay, Houston, TX (US); Dan R. Whitcher, Sugar Land, TX (US); Steven M. Plumb, Houston, TX (US)

Correspondence Address: LOREN G. HELMREICH, 5851 San Felipe, SUITE 975, HOUSTON, TX, 77057, US

(21) Appl. No.: 12/828,897

(22) Filed: Jul. 1, 2010

Related U.S. Application Data
(60) Provisional application No. 61/222,762, filed on Jul. 2, 2009.

(51) Int. Cl. C02F 1/04; B01D 3/10; B05B 7/30

(52) U.S. Cl. 203/11; 202/185.1; 239/371

(57) ABSTRACT

A system for desalinating water includes a generally cylindrical enclosure (10) and a vacuum generator (46) for forming a partial vacuum within the enclosure. Eductor (24) within a lower end of the enclosure receives heated air and brine water, and outputs a mixture of heated air and water vapor and droplets into the enclosure. Condensate collector (34) is positioned above the eductor for collecting desalinated condensate, and heat exchanger (18) above the condensate collector transfers heat within the enclosure to the brine water and condenses the water vapor to desalinated condensate.

### CROSS REFERENCE TO RELATED APPLICATION

This application claims the priority of U.S. Provisional Application No. 61/222,762 filed on Jul. 2, 2009, the disclosure of which is incorporated herein by reference for all purposes.

### FIELD OF THE INVENTION

The present invention relates to systems and methods to remove salt from seawater to obtain substantially salt-free or potable water. More particularly, this invention relates to a relatively simple and low cost technique for removing salt from seawater, with a relatively high efficiency and a substantially lower cost than prior art techniques.

### BACKGROUND OF THE INVENTION

Various techniques have been devised for desalinating water. Most commercially available techniques to desalinate water involve reverse osmosis or different forms of flash distillation, each of which has a significant manufacturing, operating and maintenance costs.

U.S. Pat. No. 3,400,074 discloses early technology directed to desalination utilizing centrifugal reverse osmosis. U.S. Pat. No. 4,333,832 discloses a rotating separation system wherein the desalinated water passes through a large surface area membrane.

Two desalination systems which utilize evaporation and condensation of the sea water are disclosed in U.S. Pat. Nos. 5,932,074 and 7,160,469. U.S. Pat. No. 5,578,209 discloses a centrifugal fluid separation device for separating raw fluids. U.S. Pat. No. 4,323,424 discloses a liquid-solid separation process. A vortex desalination system is disclosed in U.S. Pat. No. 5,078,880, and U.S. Pat. No. 5,207,928 discloses a desalination technique. Vaporized salt water droplets affect precipitation of dissolved impurities and salts from vaporizing droplets. U.S. Pat. No. 5,593,378 discloses another version of a centrifugal separator having magnets for polarizing modules. U.S. Pat. No. 5,744,008 discloses a hurricane tower desalination device wherein rising warm vapor contacts the cold plate of the heat exchanger.

Most of the above systems, while theoretically capable of generating desalinated water, utilize a great deal of energy and thus are not cost effective for many applications. In addition, many of the above devices are costly to manufacture, and are expensive to maintain in good working order.

The disadvantages of the prior art are overcome by the present invention, and an improved system for desalinating sea water is hereinafter disclosed.

### SUMMARY OF THE INVENTION

In one embodiment, a system for desalinating water includes a generally cylindrical enclosure, and a vacuum generator for forming a partial vacuum within the enclosure. A flash eductor is positioned within the lower end of the enclosure for receiving preheated air and brine water, and for outputting a mixture of heated air and brine water vapor and droplets into the enclosure. A condensate collector is positioned above the flash eductor for collecting desalinated condensate, and a heat exchanger above the condensate collector transfers heat from within the enclosure to the brine water prior to passing the brine water to the eductor, and for condensing water vapor to desalinated condensate.

These and further features and advantages of the present invention will become apparent from the following detailed description, wherein reference is made to the figures in the accompanying drawings.

### BRIEF DESCRIPTION OF THE DRAWINGS

FIG. 1 is a side view of a suitable desalination system according to the present invention.

FIG. 2 is a side view of the lower flash eductor positioned in a lower end of the enclosure shown in FIG. 1.

FIG. 3 is a top view of the lower flash eductor shown in FIG. 2.

FIG. 4 is a side view of the upper eductor which creates a partial vacuum within the enclosure.

FIG. 5 is a side view illustrating flow through the desalination system shown in FIG. 1.

### DETAILED DESCRIPTION OF PREFERRED EMBODIMENTS

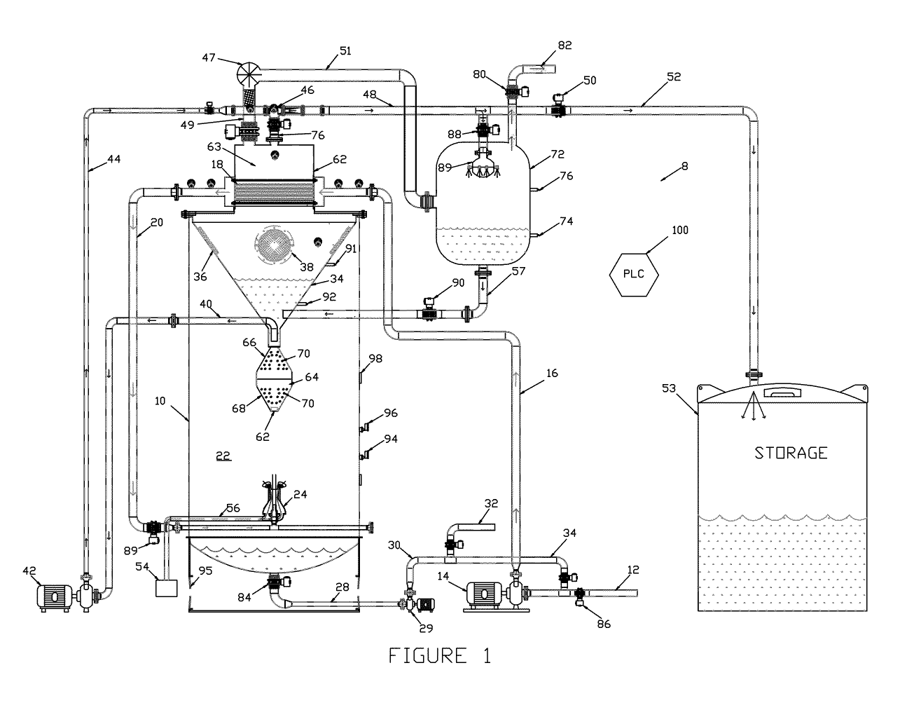

FIG. 1 illustrates one embodiment of a desalination unit or system 8 which receives salt water, e.g. sea water, from inlet line 12, and outputs desalinated water via line 52 to a storage tank or pipeline, such as storage tank 53. Desalinated water is formed within the generally cylindrical housing 10, which also houses a generally conical distillate collector 34. Hot air and salt water are flashed into the chamber 22 by eductor 24. A heat exchanger 18 is positioned within upper housing section 62, and may have a rectilinear configuration, as discussed below. The housing 10 may be supported on a plurality of legs, although in the FIG. 1 embodiment a generally cylindrical support housing 95 with one or more access doors supports the housing 10.

Salt water is input to pump 14, which provides brine water at a desired pressure along line 16 to the heat exchanger 18, where the salt water preferentially is heated about 15° F. to 25° F. from its inlet temperature, e.g., from about 85° F. to 110° F. The heated water is passed by line 20 to eductor 24, which is discussed in greater detail below. For the present, it should be understood that an air heater 50 is provided for heating a relatively small amount of air, e.g., from 300 cfm to 400 cfm, to a relatively high temperature in excess of about 100° C., and preferably from about 200° C. to 450° C. The heat source for heating the air may be a solar concentrator, waste heat from a boiler or generator, or another efficient source. Flowing high velocity salt water through the eductor 24 jet creates a vacuum which pulls in heated air from outside the housing 10. This hot air is passed via line 56 to the eductor 24, and the combination of salt water and hot air are discharged by the eductor into the interior 22 of the housing 10. Some of the superheated air and salt water flash within the chamber 22, and a high percentage of vapor and droplets are jetted upward in a jetstream which passes through the opening 62 in the lower end of the double cone device 64. Device 64 includes a conical upper portion 66 with a closed end, and a similar inverted lower conical portion 68 which includes the opening. Each portion 66, 68 has a plurality of small apertures 70 therein. The apertures 70 which may have a diameter between about 1/16 inch and ⅜ inch are sized and arranged to discharge vapor and mist within the chamber 22. Device 64 thus captures the velocity flow jetstream from flash eductor 24, and ideally breaks the jetstream into water droplets of about 50 microns or less which exit the double cone device. Larger water droplets fall back to the bottom of the housing 10 and then flash to a vapor. The eductor 24 thus outputs an unobstructed flow through opening 62 in the double cone device 64 while maintaining a desired high vacuum within the enclosure, and thus within the device 64. The high velocity jetstream flows through the air gap between the eductor 24 and the double cone device 64, which is charged by the jetstream from the eductor so that orifices 70 break the mixture into fine water droplets that have a reduced velocity and normally do not impinge the side wall of enclosure 10. High evaporation efficiency is maintained by flashing a high percentage of sea water and vapor without significant heat losses or scale formation on internal parts.

Water vapor enters the collector 34 through one of the plurality of the demisters 36, 38. In a suitable application, about six 12″-24″ demisters may be arranged circumferentially about the collector. The demisters are preferably arranged to separate the chamber 22 into an upper conical collection chamber and a generally lower evaporation chamber. The demisters allow vapor flow through the demisters while maintaining a desired pressure differential between the interior of the collector 34 and chamber 22 exterior of the collector 34. The vacuum may be maintained both within collector 34 and within chamber 22 outside of collector 34. A demister cleaning cycle may be activated when a predetermined differential occurs across the demisters. Air and vapor flow pass through the layered structure of the demisters, while liquid droplets having a greater inertia contact the demister and drop off into the chamber 22 below the demister, where they are vaporized before dropping to the bottom of the enclosure. The demisters are preferably arranged on the collector such that water droplets can easily fall from the demister, and thus are desirably positioned on slanted sides of the collector.

The top of the conical collector 34 is in fluid communication with the interior of the heat exchanger 18 due to upper housing section 62. Accumulated water (condensate) in the bottom of the collector 34 is passed via line 40 to pump 42, and then through line 44 to eductor 46. Eductor 46 passes the desalinated water downstream, and utilizes the vacuum created by the eductor to withdraw air from the upper container section 62 through line 76, and thereby maintains the desired vacuum in the chamber 22. Desalinated water continues down line 48 to control valve 50, which as explained subsequently receives signals to selectively pass some of the desalinated water through line 52 to the storage tank 53, while some desalinated water is returned via a line 54 to the interior of the collector 34 for reasons explained below.

Line 28 transmits concentrated salt water to pump 29, which pumps the brine through line 30 for possible commercial use, or returns the brine to the sea through line 32. Alternatively the pump 29 may pump fluid through line 34 and to inlet line 12 to recirculate a portion of the brine, as discussed below.

A significant feature of the invention is the use of three different flashing zones to flash salt water to vapor. The first flashing zone is the interfacial contact of the salt water and the super heated air which occurs in the eductor 24. The action of flash eductor 24 thus inherently forms a significant amount of vapor at a relatively low cost. In the vertical gap between the eductor 24 and the double cone device 64, another flashing zone exists as the jetstream from the eductor enters the partial vacuum atmosphere before the jetstream enters the double cone device 64. As previously noted, some of the water droplets falling from the double cone device saturate the incoming super heated air, and most of those droplets evaporate before falling to the bottom of the housing 10, thereby creating a third flashing zone.

The heat exchanger 18 also serves a dual purpose. It is advantageous to heat the incoming salt water to add heat to the brine before entering eductor 24. Also, heat exchanger 18 serves to condense water vapor, thereby resulting in desalinated water. The surface area of the heat exchanger is intended to condense 100% of the steam vapor produced within the housing 10. The flash eductor nozzle size and the operational output from the pump 14 determines the size of the heat exchanger (its heat transfer area) in view of the salt water input temperature and the anticipated temperature of the vapor surrounding the heat exchanger, which generally will be in the range of from 90° F. to 160° F., and preferably from 100° F. to 140° F.

The upper housing section 62 houses the heat exchanger 18 and is preferably separate from and positioned above the generally cylindrical chamber 22 formed by the housing 10. The length of the heat exchanger 18 may be less than the diameter of the housing 10, and positioning the heat exchanger within a separate housing having a horizontal cross-section only slightly larger than the cross-section of the heat exchanger minimizes “dead air” spaces within the system. In the preferred embodiment, the housing 62 is thus sized for receiving the heat exchanger therein, with upper portion 63 above the heat exchanger and below the vacuum line 76 being sized to receive accumulated air and gasses during system startup. Also, by providing a separate upper housing section 62 for the heat exchanger 18, the size of the heat exchanger and the upper housing may be easily changed to accommodate a different flow rate from the pump 14, so that the unit can be easily tailored to a specific need.

FIG. 1 also discloses an air release tank 72 which receives desalinated water from line 48 when valve 88 is open, thereby supplying water and air to container 72, which as shown has a generally cylindrical configuration. During startup condensate from pump 47 passes through line 51 to container 72. Condensate is preferably sprayed into container 72 using spray nozzles 89. Air release tank 72 may have a different shape (e.g. cylindrical) and orientation (e.g. horizontal) as its main function is the separation of aqueous and gaseous phases. As explained subsequently, water passes from the tank 72 through line 57 and back to the collector 34 during periodic operations. Housing 72 includes a low water sensor 74 and a high water sensor 76. The top of the chamber formed by housing 72 is exposed to the atmosphere through line 82, with the venting of air being controlled by valve 80.

As discussed briefly above, it should be understood that the chamber 22 has a partial vacuum in order to assist in vapor formation. Preferably the vacuum maintained within the chamber 22 will be from about 3 to 12 inches of mercury. While this vacuum may be formed by various means, including a vacuum pump, it is preferred that the vacuum be formed with an upper eductor, such as eductor 46, which pulls a vacuum within the chamber 22 created by desalinated water flowing through the upper eductor. Eductor 46 is preferably powered for high velocity flow of the distilled water from the collector 34. The water level in collector 34 may be maintained by a high level switch 91 and low level switch 92. When high level switch 91 is activated, valve 50 will open and allow water to flow to the storage tank through line 52. The valve is preferentially arranged so that flow is maintained in a closed loop until the water level rises to activate the switch 91, at which time the valve will open and allow excess desalinated water to flow through the storage tank. The eductor 46 thus creates a continuous vacuum above the heat exchanger 18 and accelerates the vapor flow across the condenser, increasing the rate of condensation. During startup, as discussed below, the desired vacuum in chamber 22 may be drawn with vacuum pump 47 which connects to chamber 63 via line 49.

The temperature and vacuum are monitored at suitable locations within the system, and provide feedback to a computer to regulate heat input and brine flow rate, allowing the system to achieve a balanced state of operation. A decrease in brine feed temperature would dictate an increase in btu input, and vice versa. The rate of condensation from the collector 34 may also require an increase in the flow rate of fluid to the eductor 46 which creates the vacuum within the enclosure. Preferably, an operational system monitors the overall vacuum within the housing 10, sea water flow rate, brine flow rate, heat input, and vapor temperature so that each parameter may be balanced to achieve a steady state of operation.

The double cone device 64 discussed above is particularly well suited for receiving a jetstream from the eductor 24, energizing or charging the interior of the device, and outputting vapor and fine droplets of about 50 microns or less. Although other configurations for such a device are feasible, the current design is particularly beneficial since the incoming jetstream, once passing through the opening 62, expands in the lower inverted cone section 68, and is effectively charged or compressed in the upper cone section 66. The size and number of apertures 70 may be easily controlled as a function of a known or presumed flow rate of sea water to the system, and the knowledge that approximately two-thirds of the water volume from the eductor 24 passes into the device 64, so that the flow rate from the plurality of apertures is sized for accommodating this flow. In many applications, the jetstream from the eductor 24 to the double cone device 64 will have a nominal diameter of about 1 to 1.5 inches, and this substantially constant jetstream diameter exists from eductor 24 and continues upward to the similarly sized opening 62. The known flow rate from each of the holes 70 is also calibrated so that the fine mist output by the double cone device does not cause a substantial portion of the mist to impinge the side walls of the container 10.

The unit 8 as disclosed herein substantially eliminates the need for multiple stages to achieve product rates comparable to prior art systems. Rather than take a portion of the salt out of the salt water in multiple stages, the system 8 is able to output substantially salt free water. Water output can be increased by providing a plurality of units in parallel, and the size of the unit may also be increased from a 30 foot high tank with an 8 foot diameter to, e.g., a 45 foot high tank with an 8 foot diameter, or other larger or smaller dimensions. The internal components can be increased or decreased to accommodate the processing of additional or less sea water and for applications other than sea water. The internal components can be sized to match the larger or smaller pressure vessel, thereby setting the desired capability for an operational system with a housing 10. Many of the system components are of a standard size. The desalinated water produced by the system 8 has various purposes and typically will retain only about 1 to 10 ppm of dissolved solids. The water preferentially is treated and demineralized for potability.

A descaling system consisting of tanks and pumps may be used to clean the tank chambers while isolating the cleaned system from the remaining desalination units. The unit may be periodically cleaned utilizing citric acid, or by other commercial cleaning techniques.

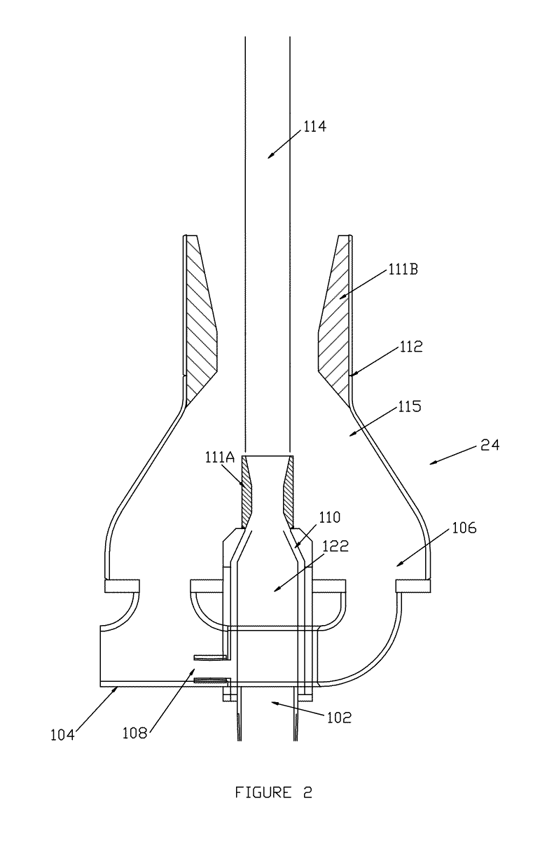

FIG. 2 is a detailed drawing of the eductor 24 generally shown in FIG. 1, which may be supplied with heated water from a centrifugal pump. Salt water inlet 102 is thus in fluid communication with flow line 20 from the heat exchanger 18. Heated air from line 56 is input to manifold 104, which includes a plurality of circumferentially arranged inlet ports 106 A, B, C and D which are each radially outward of the line 104. Tube 108 is another hot air line which has its inlet connected to the line 56, and its discharge to annulus 110 to pull superheated air through the tube 108. Diffuser section 111A thus receives a combination of the heated air and brine discharged along axis 114, and this flow is mixed with flow from the plurality of hot air discharge outlets 106 surrounding the nozzle 122. The eductor 24 provides two low pressure zones within a single housing. The nozzle 122 passes both brine from line 102 and heated air from line 106 A, B, C and D pulled in from outside the chamber 22 by the vacuum created by the flowing brine exiting the line 102. This smaller eduction nozzle 122 and downstream diffuser section 111A are arranged on a center drive to convert high pressure to high velocity flow, pulling an effective vacuum in the annulus 110 arranged around the nozzle upstream of the diffuser, and discharging a jet stream 114 into the chamber 22.

The discharge diffuser 111B receives the high velocity flow from the diffuser 111A and creates another vacuum zone that pulls air through the manifold 104, thereby allowing hot air to be drawn from outside the housing 10 to the area radially outward of the jet nozzle 122. As the combined hot gases and water flash as they leave the two diffuser sections 111A and B, they enter a low pressure zone. The pressure decrease and velocity increase created by this second chamber or zone within diffuser 111B cause a second vacuum zone to pull in additional liquid and/or gas through line 104A, 104B which are in fluid communication with the heat source 54. Diffuser 111B may experience wear, and preferably is a replaceable component within diffuser housing 112. This mechanism provides an effective means for regulating heat flow to the eductor 24 and maintains a set point temperature sufficient to flash water.

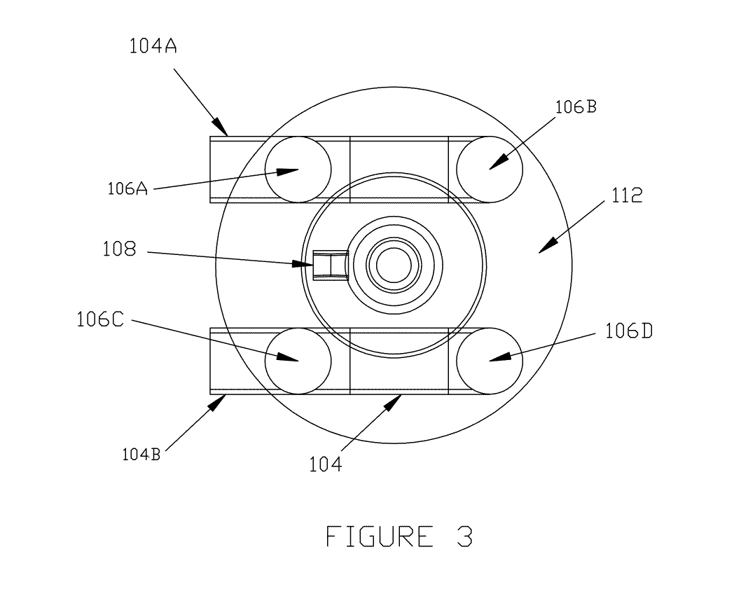

FIG. 3 is a top view of the eductor 24 generally shown in FIG. 2. Hot air may be input to manifold through one or more input lines 104A, 104B. Hot air from the manifold is discharged upward through the ports 106A, B, C and D each in fluid communication with the manifold, while hot air simultaneously enters the chamber 115 as shown in FIG. 2 through the input line 108.

The eductor 24 as shown in FIGS. 2 and 3 is one embodiment of a suitable eductor for efficient mixing of the brine and the heated air in a manner which optimizes the creation of vapor and the generation of a jetstream, as discussed above. Pump 14 pressurizes the brine so that a high velocity jetstream will issue from the nozzle 110, which creates a strong vacuum to pull hot air into the manifold 104 and flow line 108. Eductor 24 mixes the brine and the heated air to cause flashing of a portion of the brine to vapor.

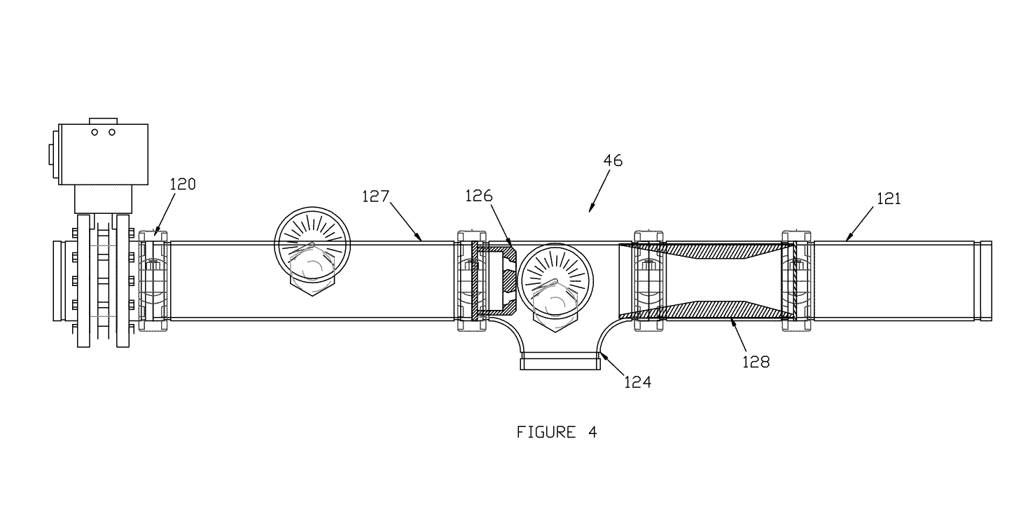

FIG. 4 is a detailed drawing of the eductor 46 as generally shown in FIG. 1, which creates the vacuum within the chamber 22. Inlet 120 to the eductor 46 is thus in fluid communication with line 44 from the pump 42, and the outlet 121 from the eductor 46 is in fluid communication with flow line 48, as shown in FIG. 1. Vacuum inlet 124 is thus in fluid communication with line 76 and with the interior of the top housing section 62. Nozzle 126 passes desalinated water in a manner which creates a vacuum downstream from nozzle 126, and that vacuum draws in air from the chamber 22. Eductor 46 preferably utilizes a multi-nozzle jet 126 and a diffuser section 128, thereby creating a low-pressure vacuum which draws vapor (steam) across the heat exchanger, thereby creating condensate and removing air from the chamber 22 to maintain a desired partial vacuum within the chamber 22. The eductor 46 is arranged above heat exchanger 18 which allows vapor flow through the demisters 36, 38 and also assists the eductor 24 to pull in additional superheated air. The superheated incoming air is connected to a header with four connections arranged on the device that allows additional hot gasses to be drawn in from outside the shell through interconnecting piping and valves. The valves will regulate heat flow to the device in the second stage thereby controlling the temperature inside the evaporator. Pump 42 pressurizes the desalinated water to a range of about 200-300 psi to the eductor 46 to pull a vacuum within the chamber.

The operational sequence for startup of the system preferably includes a computer 100, which receives wired and/or wireless signals from the various sensors discussed below, and controls the operation of the valves and pumps to achieve the objectives set forth herein. Prior to starting the system, both enclosures 34 and 72 may have some water therein. Vacuum pump 47 may first be started, then heat flow commenced from source 54 to eductor 24. Pump 14 may then be started and the vacuum monitored within chamber 22. When the vacuum reaches approximately 7 inches Hg, the vacuum pump 47 may be stopped because flow from pump 42 to the eductor 46 will now maintain the minimum required vacuum within the chamber 22. As soon as sufficient condensate is collected in 34, the pump 42 may be activated, thus drawing a vacuum in the chamber 22 through the line 76. Vacuum pump 47 may be fluidly connected to each of multiple condensation units, so that each of several units may be started with a vacuum control to a specific unit. Also, water (condensate) may be left in or pumped to collector 34 and/or enclosure 72, so that flow from pump 42 may initially activate eductor 46, thereby obviating the need for vacuum pump 47. A closed loop is thus initially formed through the eductor 46. Fluid passing by the eductor 46 may pass through the open valve 88 and to the chamber 72. Air may be vented from the chamber 72 through the open valve 80 and line 82. Once the condensate is to the high level switch 76, valve 90 may be opened, returning some of the condensate to the collector 34. The condensate level in the chamber 72 is thus maintained at a level sufficient to vent gas while maintaining a vacuum in the chamber 22. When the condensate level in container 34 rises to the level of switch 91, valve 50 may be incrementally opened to begin discharging water to storage tank 53.

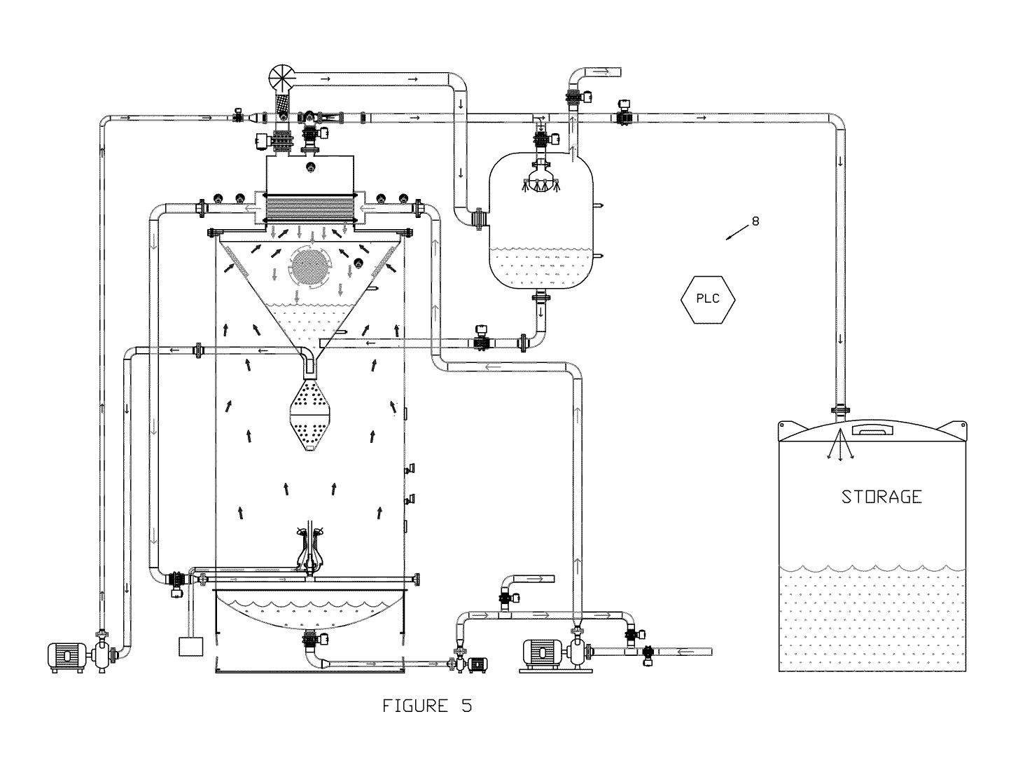

When startup is complete, the system may be maintained in an operational mode. Vacuum in the chamber 22 may be monitored with the vacuum sensor 94, and the temperature within the chamber 22 may be monitored with temperature sensor 96. Sight glass 98 may be provided for viewing the flow within the chamber 22. Flow rate, flow temperature and vacuum may be adjusted, and the system balanced by monitoring various sensors, including the flow rate and the temperature of both the incoming sea water and the heated air. A desired differential temperature is maintained between the sea water inlet to the heat exchanger and the vapors flowing across the heat exchanger. The steady state temperatures of the flash vapors are maintained within the saturation temperature and pressure levels to achieve a balanced state which changes within an expected operational range. FIG. 5 shows the flow of fluids through the system.

The amount of sea water that flows through the condenser may be substantially constant by using a selected orifice jet size for the eductor 24. For example, an orifice of 9/16 inch diameter allows 320 gallons per minute flow at 60 psi. A larger jet will allow more flow, while a smaller jet allows less flow. A control valve may be used to regulate the flow. Heat input to the housing of the evaporator housing 10 will increase if a larger jet is installed and will decrease if a smaller jet is used. The heat balance inside the evaporator housing is maintained by sensor measurement feed back to the PLC which changes the valve positions on one or more of the hot air lines coming into the lower eductor 24 to maintain a constant temperature adjacent the condenser of approximately 100° F.-140° F. Brine that passes through the condenser picks up heat. The amount of temperature increase in the brine at the condenser is directly proportional to the heat input by the lower eductor 24, the vacuum maintained in the housing, and the brine injection temperature.

As the brine temperature increases, less outside hot air is needed to flash or evaporate the incoming sea water to vapor. As the brine temperature increases, the hot air may be decreased by the proportioning heat valves to the lower eductor 24. When the amount of hot gases drawn into the housing 10 is decreased, the vacuum will increase in the housing 10. An increase in vacuum causes a corresponding decrease in flashing temperature and changes the differential temperature between the incoming sea water and the steam vapor. This temperature differential may be measured and maintained within a heat balance that is calibrated into the operational logic of the PLC 100 based on an operational range that assures the desired sweet water output.

The sea water flow may be presumed constant and the sea water temperatures are typically constant, changing only from season to season. The vacuum changes with a temperature increase or decrease in the housing 10. By controlling the temperature and maintaining all other parameters relatively constant, the system will achieve a relatively constant balance of heat input and vacuum operating at from 3 inches Hg up to 12 inches Hg with a calibrated temperature set point of approximately 100° F.-140° F. A specific heat to vacuum balance allows sea water to change from a liquid to a vapor at a constant rate of evaporation.

Most evaporators are designed to maintain a selected water temperature, while the present system maintains a constant chamber temperature/vacuum relationship in the lower portion of the evaporator and relies on partial flashing of the incoming sea water by inner facial contact with superheated air adjacent the eductor 24, then breaking the remaining high velocity flow into water droplets to induce additional flashing of the sea water in the lower chamber as droplets fall to the lower section of the evaporator.

As shown in FIG. 5, vapor formed in the lower section of the evaporator chamber 22 is drawn up and through demisters 38 arranged about the conical sweet water storage tank 34 inside the evaporator housing. As the vapor passes through the demisters, any salt remaining in the vapor will be captured by the demisters. A solid salt particle will cause a liquid drop to form at the demister surface. When the drop becomes large enough, it will fall back to the lower area of the evaporator chamber 22.

The condenser 18 arranged above the demisters 38 is sealed within the housing so that all vapor passing through the demisters is drawn across the condenser by the vacuum pump 47 or by the upper eductor 46. The incoming sea water may be a nominal temperature between 65° F.-85° F., and the steam vapor temperature directly below the condenser is a nominal 120° F.-135° F. The total area of the condenser tubes, the sea water temperature, the tube arrangement in the condenser and the amount of flow through the condenser determines the rate of condensation and the condensate temperature.

Latent heat transfer occurs whereby the steam vapor at higher temperatures thermally exchanges with the sea water flow through the sealed condenser. The result is a near 100% change from vapor to condensate, so that the vapor becomes a liquid and falls into the cone tank storage unit 34 of the evaporator while air and non condensable gases pass through the upper eductor 46 and are discharged to the atmosphere outside the evaporator.

As shown in FIG. 1, a portion of the brine in the lower evaporator may be pumped back to the incoming sea water to reduce heat losses from brine pumped back to the sea. The sea water to the eductor 24 is maintained not to exceed 65,000 parts per million total dissolved solids.

Energy required for brine evaporation using conventional technology is typically from 5.5 to 7.0 KW/meter³ of condensate, while the present system provides the same production using significantly less energy per meter³ of condensate. Heat for the flashing, evaporation and condensing of sea water to vapor may alternatively be provided by a solar array arranged in sequence with airflow through the solar panels designed to heat outside ambient air to a desired temperature with a continuous flow of about 12.5 to 500 SCFM of air. Other means of heat sources for the air flow include waste heat, natural gas fired heaters, diesel fired heaters, steam, kerosene, electric, bio mass, bio diesel, and other combustion processes that may sustain a constant heated air temperature of about 80° C.-140° C. The heated air is pulled into the evaporator housing and introduced at the lower eductor 24 by a vacuum of about 25-29.9 inches Hg developed by the lower eductor 24.

The vacuum on the shell may be maintained at about 3 to 12 inches Hg by the upper eductor 46 assembly or vacuum pump 47. The hot airflow at about 80° C.-400° C. may be controlled by proportioning valves arranged along the line from the outside heat source of the evaporator. These proportioning valves may be controlled by a programmed logic that operates within calibrated design parameters. The feedback from transducers thus provides the input to the calibrated logic. The operational logic may also control shell temperature and vacuum.

System shutdown may be performed by stopping pumps 14 and 42, and closing all valves. Pump 29 may be briefly started to remove all brine water from the lower portion of chamber 22. Cleaning may be commenced using a citric acid solution pumped in a closed loop to remove scale from internal components of the system. The demisters 36, 38 may be cleaned by backflowing distilled water through the demisters. A brine and citric acid combination may be removed by opening valve 84 and briefly operating pump 29 so that the citric acid solution and scale are discharged.

The housing 10 as disclosed herein forms a generally cylindrical internal chamber. While a cylindrical housing is suitable for many applications, the housing could have a frustoconical configuration, with the central axis of the housing still being in line with the central axis of the mixing eductor. The housing nevertheless is symmetrical about its central axis.

The system as disclosed herein utilizes a heat exchanger above the condensate collector for transferring heat from within the enclosure to the brine water prior to passing the brine water to the eductor, and for condensing water vapor to desalinated condensate. While this arrangement is preferred for many applications, there may be situations wherein a heat source is readily available for heating the brine water before entering the desalination system, e.g., from solar collectors or from a waste heat source. In those applications, a heat exchanger as disclosed herein may be replaced with a condenser which condenses water vapor to desalinated condensate, but does not heat the brine water coming through the mixing eductor.

The system disclosed herein may be used in applications that do not involve desalination. For example, the system as disclosed herein may be used to efficiently remove water, so that a more concentrated solution is output from the lower end of the tank. In other applications, the system may be used for cleaning runoff water from farmlands, or to reprocess gray water, thereby possibly reclaiming nutrients and providing potable water.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A system for desalinating water, comprising:
a symmetrical enclosure having a central axis;
a vacuum generator for forming a partial vacuum within the enclosure;
a jetstream eductor within a lower end of the enclosure for receiving heated air and brine water, and for outputting a mixture of heated air and water vapor and droplets into the enclosure;
a condensate collector positioned above the jetstream eductor for collecting desalinated condensate; and
a heat exchanger above the condensate collector for transferring heat within the enclosure to the brine water prior to passing the brine water to the jetstream eductor, and for condensing water vapor to desalinated condensate.

2. A system as defined in claim 1, further comprising:
a mixture receiving unit spaced axially above the jetstream eductor and having an opening inline with a centerline of the jetstream from the jetstream eductor for receiving at least a portion of the jetstream; and
a plurality of holes in side walls of the mixture receiving unit for outputting vapor and mist.

3. A system as defined in claim 2, wherein a mixture receiving unit has a generally conical upper chamber therein and a generally inverted conical lower chamber therein, the lower end of the lower chamber including an opening for receiving a portion of the jetstream; and
side walls of the eductor include a plurality of ports for passing fluid from each of the upper chamber and the lower chamber.

4. A system as defined in claim 2, wherein the jetstream eductor is positioned within the enclosure such that a jetstream eductor central axis is substantially aligned with the enclosure central axis, and wherein the opening in the mixture receiving unit is aligned with the enclosure central axis.

5. A system as defined in claim 4, wherein the condensate collector has a collector central axis aligned with the enclosure central axis.

6. A system as defined in claim 1, wherein the vacuum generator comprises a vacuum eductor transmitting desalinated condensate therethrough, the vacuum eductor drawing the partial vacuum within the enclosure.

7. A system as defined in claim 1, further comprising:
an upper enclosure positioned above the symmetrical enclosure and housing the heat exchanger, a lower end of the upper enclosure being in fluid communication with an upper end of the symmetrical enclosure, and the upper enclosure being in fluid communication with the vacuum generator.

8. A system as defined in claim 1, wherein the generally cylindrical enclosure includes a bowl shaped lower end for collecting and removing brine water from the enclosure.

9. A system as defined in claim 1, wherein the vacuum generator maintains an operating vacuum within the enclosure of from about 3 to 12 inches of mercury.

10. A system as defined in claim 1, further comprising:
a heat source for heating the air to the jetstream eductor to a temperature of from about 350° C. to 450° C.

11. A system for desalinating water, comprising:
a generally symmetrical enclosure defining a central axis;
a vacuum generator for forming a partial vacuum within the enclosure;
a jetstream eductor within a lower end of the enclosure for receiving heated air and brine water, and for outputting a mixture of heated air and water vapor and droplets into the enclosure, the jetstream eductor positioned within the enclosure such that a jetstream eductor central axis is substantially aligned with the enclosure central axis;
a condensate collector positioned above the jetstream eductor for collecting desalinated condensate;
a condenser above the condensate collector for condensing water vapor to desalinated condensate;
a container exterior of the symmetrical enclosure for receiving desalinated condensate, the container having an upper chamber therein which may be opened to atmosphere; and
a flow line from the container to the condensate collector, thereby returning a portion of the desalinated condensate to the collector.

12. A system as defined in claim 11, further comprising:
a mixture receiving unit spaced axially above the jetstream eductor and having an opening inline with a centerline of the jetstream from the jetstream eductor for receiving at least a portion of the jetstream; and
a plurality of holes in side walls of the mixture receiving unit for outputting vapor and mist.

13. A system as defined in claim 12, wherein the condensate collector has a collector central axis aligned with the enclosure central axis.

14. A system as defined in claim 11, wherein the vacuum generator comprises a vacuum eductor transmitting desalinated condensate therethrough, the vacuum eductor drawing the partial vacuum within the enclosure.

15. A system as defined in claim 11, further comprising:
an upper enclosure positioned above the symmetrical enclosure and housing the heat exchanger, a lower end of the upper enclosure being in fluid communication with an upper end of the symmetrical enclosure, and the upper enclosure being in fluid communication with the vacuum generator.

16. A system as defined in claim 11, wherein the condenser comprises a heat exchanger for transferring heat from the enclosure to the brine water prior to passing the brine water to the jetstream eductor.

17. A system for desalinating water, comprising:
a generally symmetrical enclosure defining a central axis;
a vacuum eductor transmitting desalinated condensate therethrough, the vacuum eductor drawing a partial vacuum within the enclosure;
a jetstream eductor within a lower end of the enclosure for receiving heated air and brine water, and for outputting a mixture of heated air and water vapor and droplets into the enclosure, the jetstream eductor positioned within the enclosure such that a jetstream eductor central axis is substantially aligned with the enclosure central axis;
a condensate collector positioned above the jetstream eductor for collecting desalinated condensate;
a condenser above the condensate collector for condensing water vapor to desalinated condensate; and
a mixture receiving unit spaced axially above the jetstream eductor and having an opening inline with a centerline of the jetstream from the jetstream eductor for receiving at least a portion of the jetstream, the mixture receiving unit having a generally conical upper chamber therein and a generally inverted conical lower chamber therein, a lower end of the lower chamber including an opening substantially aligned with the enclosure central axis for receiving the jetstream, and a plurality of holes in side walls of the mixture receiving unit for outputting vapor and mist.

18. A system as defined in claim 17, wherein the condensate collector has a collector central axis aligned with the enclosure central axis.

19. A system as defined in claim 17, further comprising:
an upper enclosure positioned above the symmetrical enclosure and housing the heat exchanger, a lower end of the upper enclosure being in fluid communication with an upper end of the symmetrical enclosure, and the upper enclosure being in fluid communication with the vacuum generator.

20. A system as defined in claim 17, wherein the condenser comprises a heat exchanger for transferring heat from the enclosure to the brine water prior to passing the brine water to the jetstream eductor.

21. A system as defined in claim 17, wherein the vacuum generator maintains an operating vacuum within the enclosure of from about 3 to 12 inches of mercury.

22. A system as defined in claim 17, further comprising:
a heat source for heating the air to the eductor to a temperature of from about 350° C. to 450° C.

23. A method of desalinating water, comprising:
providing a symmetrical enclosure having a central axis;
pulling a partial vacuum within the enclosure;
positioning an eductor within a lower end of the enclosure for receiving heated air and brine water and outputting a mixture of heated air and water vapor and droplets into the enclosure;
positioning a condensate collector above the eductor for collecting desalinated condensate; and
positioning a condenser above the condensate collector for condensing water vapor to desalinated condensate.

24. A method as defined in claim 23, wherein the condenser is a heat exchanger for also transferring heat from within the enclosure to the brine water prior to passing the brine water to the eductor.

25. A method as defined in claim 23, wherein the operating vacuum within the enclosure is from about three to about twelve inches of mercury.

26. A method as defined in claim 23, further comprising:
heating the air to the eductor to a temperature of from about 350° C. to 450° C.

27. A method as defined in claim 23, further comprising:
providing a container exterior of the symmetrical enclosure for receiving desalinated condensate, the container having an upper chamber therein which may be opened to the atmosphere; and
providing a flow line from the container to the condensate collector to return a portion of the desalinated condensate to the collector.

28. An eductor for flashing brine from a brine inlet line to water vapor, comprising:
a nozzle downstream from the brine increasing flow velocity through the nozzle;
a first diffuser section downstream from the nozzle;
a first hot air line for fluid communication with an annulus surrounding the brine inlet line, the annulus being in fluid communication with the downstream nozzle such that a first low pressure zone draws hot air through the annulus and through the nozzle;
a second diffuser section downstream from the nozzle and the first diffuser section and circumferentially surrounding the nozzle and the first diffuser section;
a second hot air line in fluid communication with the second diffuser section via a plurality of flow ports each spaced radially from and circumferentially about the brine inlet line, such that a second low pressure zone within the second diffuser section draws hot air through the second hot air line and into the second diffuser section.
